(19) United States
(12) Patent Application Publication
(10) Pub. No.: US 2004/0044567 A1
(43) Pub. Date: Mar. 4, 2004

(54) Gaming service provider advertising system

(76) Inventor: Daniel Willis, Stittsville (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/232,603

(22) Filed: Sep. 3, 2002

(51) Int. Cl. G06F 17/60

(52) U.S. Cl. 705/14

(57) ABSTRACT

A method of advertising for use by a Gaming Service Provider providing a customer gaming console in connection with a wide area network is disclosed. The method includes the steps of providing an identification from the customer gaming console to a Gaming Service Provider downloading an advertisement out of a plurality of advertisements to the customer gaming console, initializing the customer gaming console for playing a game and for displaying the advertisement, playing a game on the customer gaming console, and displaying the advertisement on the customer gaming console, when the game is not being played. Alternatively, the steps of the method are not initialized by the Gaming service provider, but from the gaming console site. Further, certain games played on the gaming console incorporate advertisements into their gaming environments.

### FIELD OF THE INVENTION

The present invention relates to advertising on a gaming console, and particularly to advertising on a gaming console connected to a wide area network.

### BACKGROUND OF THE INVENTION

The Internet network, as of now, is a free enterprise network. Neither government nor big business owns or regulates its content or procedures, thus allowing for a liberal dissemination of information. The cost for marketers or purchasers to use the net is very low, thus enabling both groups to make or save money. There are, however, problems to consider in this cyberspace wonderland. The general attitude towards Internet exhibited by the common user of Internet services is that the Internet is also free in the sense of free of charge. This as a consequence causes a considerable financial burden for many professional providers of services on the Internet network.

A common solution to this problem is Internet advertisement. Advertising holds the promise to be the ticket to prosperity for many Internet services. By now, the Internet network is becoming increasingly popular among businesses as an avenue for marketing their products and services. The system is growing rapidly, and net research agencies estimate that spending for online advertisement for the year 2001 totaled $2.5 billion in the United States. Despite a drop from the year 2000 to the year 2001, it is expected that the market will do even better in the coming future. With the year 2002 already showing signs of improvement, it is expected that Internet advertisement spending will lead the way in 2002, in terms of significant growth, up 8.8% from its 2001 total.

For an advertiser, the value of advertising is the ability to direct an advertisement to a specific group of consumers. Control over the advertisement in terms of when, where, how, and to whom an advertisement is communicated is of paramount importance to the advertiser. Thus, targeted advertising, which offers compelling content aimed at a specific demographic market, will be the future of advertisement on the Internet network.

The general idea of targeted advertising on the Internet is well advocated, and is for example described in U.S. Pat. No. 6,339,761 to Cottingham, issued Jan. 15, 2002. With the major advances in Internet supporting software as well as Internet data protocols, it is going to get easier to track who a person is, and what she or he likes. Therefore, both the frequency as well the success rate of targeted advertising on the Internet are likely to increase in the near future.

Until the present, the main efforts in advertising on the Internet network have been directed towards placing advertisements within specific websites. Thus, the current systems and methods for advertising on the Internet network are developed having in mind Internet Service Providers (ISP) as main users. There are however other major developments taking place, which hold a promising future for advertisement on the Internet network. During the last couple of years, on-line computer gaming has gained increasing popularity, and different Gaming Service Providers (GSP) have established themselves on the Internet network. On-line computer gaming is fast becoming a major money generating competitive virtual sport with tournament organizations and ranking services dedicated to providing the online community with the latest information and current rankings of global Internet gamers and game players. An interactive game server and online community forum is for example described in U.S. Pat. No. 6,339,761 to Sparks II, issued Mar. 5, 2002.

When talking about Internet gaming, one has to distinguish between two different scenarios. A common gaming situation takes place when an Internet user visits a site providing Internet gaming, and plays Internet games using his common Internet browser as the gaming interface. A popular site following this strategy is for example the game site http://zone.msn.com. A visit of this site impressively demonstrates the importance Internet advertising in connection with Internet gaming has gained. In this gaming situation, the user usually plays a game in a single user environment. A second gaming scenario is characterized by the situation that the one user plays interactively together with or against other users. The gaming provider (GSP) establishes the exchange of gaming related information between all the users involved in a certain gaming situation. Typically, in this gaming scenario, the user utilizes a particular gaming console (GC), especially equipped with hardware and software requirements for advanced graphics, enhanced sound support, and the like, and retrieves information regarding a particular game situation from the GSP. This way, a truly interactive gaming experience is achieved.

The tentative use of an interactive computer game to publicize a new movie also demonstrates a new potential use of on-line gaming in advertisement. The interactive computer game was set up to allow the user to explore the set of the movie, meet major characters, and provide feedback to the directors on the potential outcome of the story while the film was still in production. It is very possible that directors and studios will use such interactive games in order to test the market's receptiveness to new story concepts. In addition, a feeling of anxiousness can be formed around the release of a movie without any of the traditional high-cost media vehicles. It is conceivable that a much better advertising campaign could be run through the net and an interactive on-line computer game than could ever be run with conventional means.

In view of the financial benefits resulting for providers of services utilizing the Internet network, in view of the growing popularity of on-line gaming, as well as in view of the potential impetus interactive gaming is able to provide in the fields of advertising and marketing, it is highly advantageous to combine the common ideas and strategies of advertising on the Internet network with interactive entertainment on the Internet network in general, and specifically with on-line gaming.

### OBJECT OF THE INVENTION

It is therefore an object of the present invention to provide a method for advertising on a gaming console.

It is further an object of the present invention, to provide a method for advertising on a gaming console connected to a wide area network.

It is another object of the present invention, to provide a method for advertising on a gaming console for interactively playing games in a multi-user environment.

### SUMMARY OF THE INVENTION

In accordance with an aspect of the instant invention, there is provided a method of advertising for use by a Gaming Service Provider providing a customer gaming console in connection with a wide area network, the method comprising the steps of, providing an identification from the customer gaming console to a Gaming Service Provider, downloading an advertisement out of a plurality of advertisements to the customer gaming console, initializing the customer gaming console for playing a game and for displaying the advertisement, playing a game on the customer gaming console, and displaying the advertisement on the customer gaming console, when the game is not being played.

In accordance with an aspect of the instant invention, there is further provided a storage medium having stored therein data, the data for performing the steps of providing an identification from a customer gaming console to a Gaming Service Provider, downloading an advertisement out of a plurality of advertisements to the customer gaming console, initializing the customer gaming console for playing a game and for displaying the advertisement, playing a game on the customer gaming console, and displaying the advertisement on the customer gaming console, when the game is not being played.

In accordance with another aspect of the instant invention, there is provided a method of advertising for use with a customer gaming console, the customer gaming console being in connection with a wide area network, the method comprising the steps of sending an identification from the customer gaming console to a Gaming Service Provider, uploading an advertisement out of a plurality of advertisements to the customer gaming console for displaying the advertisement on the customer's gaming console, initializing the customer gaming console for playing a game and for displaying the advertisement, playing a game on the customer gaming console and displaying the advertisement on the customer gaming console, when the game is not being played.

In accordance with another aspect of the instant invention, there is further provided a storage medium having stored therein data, the data for performing the steps of sending an identification from a customer gaming console to a Gaming Service Provider, uploading an advertisement out of a plurality of advertisements to the customer gaming console, initializing the customer gaming console for playing a game and for displaying the advertisement, playing a game on the customer gaming console, and displaying the advertisement on the customer gaming console, when the game is not being played.

In accordance with another aspect of the instant invention, there is provided a method of advertising on a gaming console, the method comprising the steps of loading a game stored on a local storage device onto the gaming console, loading an advertisement out of a plurality of advertisements stored on the local storage device to gaming console, initializing the gaming console for playing the game and for displaying the advertisement, playing the game on the gaming console, and displaying the advertisement on the gaming console.

In accordance with another aspect of the instant invention, there is further provided a storage medium having stored therein data, the data for performing the steps of loading a game stored on a local storage device onto the gaming console loading an advertisement out of a plurality of advertisements stored on the local storage device to gaming console, initializing the gaming console for playing the game and for displaying the advertisement, playing the game on the gaming console, and displaying the advertisement on the gaming console.

In accordance with yet another aspect of the instant invention, there is provided a method of advertising for use by a Gaming Service Provider comprising the steps of receiving an identification from a customer gaming console by a Gaming Service Provider, sending an advertisement out of a plurality of advertisements to the customer gaming console for displaying the advertisement on the customer's gaming console, downloading a game to be executed to the customer gaming console, and displaying the advertisement on the customer gaming console while the game is being executed on the customer gaming console.

In accordance with yet another aspect of the instant invention, there is further provided a storage medium having stored therein data, the data for performing the steps of receiving an identification from a customer gaming console by a Gaming Service Provider, sending an advertisement out of a plurality of advertisements to the customer gaming console for displaying the advertisement on the customer's gaming console, downloading a game to be executed to the customer gaming console, and displaying the advertisement on the customer gaming console while the game is being executed on the customer gaming console.

### BRIEF DESCRIPTION OF THE DRAWINGS

Exemplary embodiments of the present invention will be described in conjunction with the following drawings, in which similar reference numbers designate similar items:

FIG. 1 displays a simplified flow diagram for advertisement display on a customers gaming console (GC) according to a first embodiment of the present invention;

FIG. 2 displays a simplified flow diagram for advertisement display on a customers gaming console including the steps of establishing a customer's personal profile (CPP) and assessing the game console's availability according to a second embodiment of the present invention;

FIG. 3 displays a simplified flow diagram for advertisement on a customers gaming console, further including the step of storing advertisements in a temporary buffer (TB) according to a third embodiment of the present invention;

FIG. 4 displays a simplified flow diagram for advertising on a gaming console according to a fourth embodiment of the present invention;

FIG. 5 displays a schematic screenshot of a game played on a customer gaming console, incorporating advertisement; and

FIG. 6 displays another schematic screenshot of a game played on a customer gaming console, incorporating animated advertisement.

### DETAILED DESCRIPTION OF THE INVENTION

The present invention is now described with respect to displaying advertisements on a gaming console (GC), which is used by a customer of a Gaming Service Provider (GSP) to interactively play a game. The customer starts a particular game on his gaming console, and connects to the Gaming Service Provider to retrieve particular gaming scenarios, or to participate in an interactive gaming situation involving a plurality of interactive gaming participants. Optionally, the customer retrieves gaming software from the Gaming Service Provider. Before an advertisement is displayed on a customers gaming console (GC), the customer establishes a connection to the Gaming Service Provider (GSP), and requests particular gaming information. After the connection has been successfully established, the Gaming Service Provider (GSP) sends the requested information, and optionally additional advertisements to the customer's gaming console (GC).

The present invention need not be restricted to advertising on a gaming console (GC), but equally applies to advertising on any other connection device, which establishes a connection between a customer and a Gaming Service Provider (GSP), which enables an interactive gaming environment, and which emulates the function of a gaming console (GC).

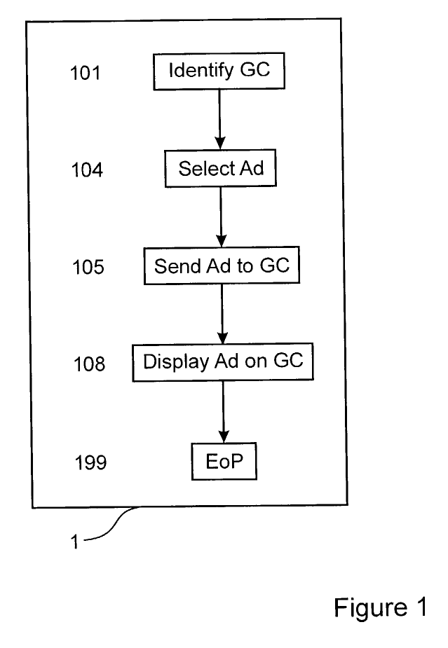

Referring now to FIG. 1, a simplified flow diagram is shown, which illustrates the principle idea of a first embodiment of the present invention. The procedure 1 of displaying an advertisement on a customer's gaming console (GC) is initiated with an identification step 101. After the customer has established the connection with the Gaming Service Provider (GSP), and has sent his gaming request, the GSP identifies the customers gaming console (GC). This identification step is for example performed by an analysis of the network address from which a particular user requests a connection to the Gaming Service Provide (GSP), when for example the Internet network is used to establish the connection. Alternatively, the identification of the gaming console is performed using a user identification and password system, or a related security system commonly used in remote access procedures. After the access authorization has been established, information about the hardware capabilities of the gaming console (GC) is retrieved. This information is related to graphic capabilities, sound capabilities, memory, and other hardware details of the GC. Once the identity of the gaming console has been established, the gaming request is processed.

In a next step 104, the Gaming Service Provider (GSP) selects an advertisement out of a plurality of advertisements. The advertisement is typically an electronic advertisement, stored on a data storage device of the GSP, such as a hard disc. The electronic advertisement is stored according to common data formats, such as Graphic Interchange Format (GIF), Tagged Image File Format (TIFF), Motion Picture Entertainment Group (MPEG) format, or any other format that complies with the hardware configuration of the gaming console (GC). Optionally, each advertisement is provided in at least one of several different formats with respect to requirements for memory and/or video and audio hardware support. According to the identity of the gaming console (GC), a corresponding data format for a particular advertisement is selected.

Commonly, the Gaming Service Provider (GSP) sells advertising space on his gaming site, and different advertisements provided by different advertisers constitute a pool of possible advertisements. The number of downloads of an advertisement to a gaming console (GC) is possibly used to determine a pricing system for the cost of an advertisement being included in the pool of advertisements. Optionally, a bidding system is set up to assists the selection and pricing of advertisements. Proposed bids submitted by different advertisers are evaluated in real time in order to determine which particular advertisement will be displayed on a gaming console. Each proposed bid can specify a price or amount that the advertiser is willing to pay for the opportunity to display an advertisement. Such a bidding system, for example, is disclosed in U.S. Pat. No. 6,285,987 to Roth et al., issued Sep. 4, 2001.

Once the advertisement has been selected, it is sent to the customer's gaming console (GC), step 105, and is displayed on the customer's GC, step 108. Depending on the format of the advertisement, the advertisement is for example displayed as a simple pop-up picture, as an animated sequence of pictures, as a sound supported picture, or as a short movie clip. After the advertisement is displayed, the end of the procedure 1 (EOP) of displaying an advertisement on the customer's gaming console is reached, step 199. Optionally, the procedure 1 is repeated. In this case, step 101 is possibly omitted, beginning the repeating procedure with step 104.

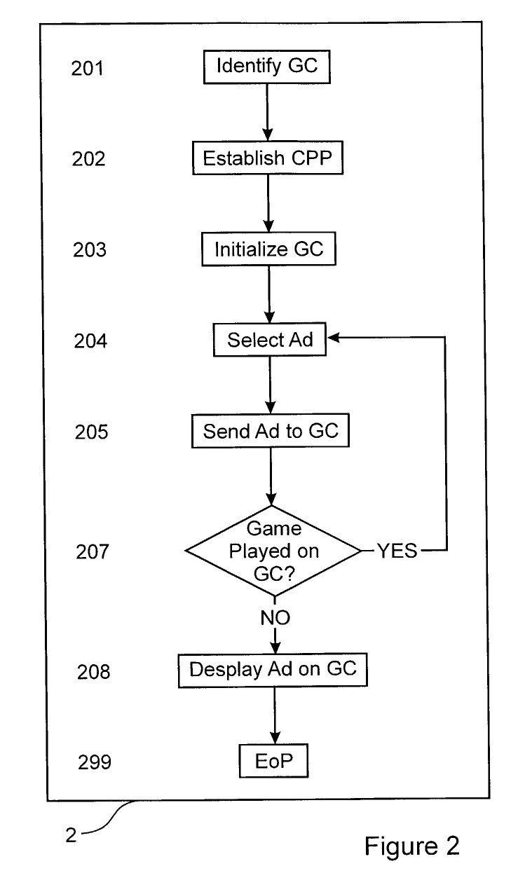

A variety of alternatives to the above-described procedure 1 are envisionable to those of skill in the art from this disclosure. An extended procedure 2 is now described with reference to FIG. 2, in which a simplified flow diagram illustrates the principle ideas of a second embodiment of the present invention. The procedure 2 is initiated with an identification step 201 that is similar to the above-described identification step 101. Again, access authorization as well as hardware configuration are ascertained. In a next step 202, a customer personal profile (CPP) is established. The customer personal profile (CPP) is accessed and modified by the customer, after a common verification procedure is executed, involving for example a user ID and a corresponding user password, or any other verification procedure commonly used a in remote access environment.

The CPP contains a variety of information regarding a specific customer. If the customer is the subscriber to the gaming service, this information is for example personal information of the customer such as age, gender, marital status, occupation and so forth, voluntarily provided by the customer. Optionally, the customer personal profile (CPP) relates to a particular customer gaming console (GC) and contains a history of the games requested from the GC. Further optionally, the CPP contains information relating to interactive gaming, such as preferences for certain interactive scenarios, and the like.

In a following step 203, the customer gaming console (GC) is initialized. In the initialization for interactive gaming, gaming information is downloaded form the GSP to the customer gaming console (GC), and interactive gaming connections are established. In the initialization for display of advertisement, the customer GC is prepared for displaying an advertisement, which includes steps such as freeing-up unneeded CPU resources, clearing unused random access memory (RAM), and other hardware related steps.

Next, an advertisement is selected, step 204. The selection process possibly occurs according to target group considerations, established by the customer personal profile (CPP), and/or the game requested. Empirical research paints an interesting CPP for the average Internet gamer. The average Internet gamer is an individual whose life is games and who loves beer. Most Internet gamers have an annual income—or are supported by someone with an annual income—that averages $70,000. Internet gamers are early adopters and are very loyal to the product or products they use. They typically tell everyone about the product or products they use, both verbally and on the Internet. The average Internet gamer is a male between the ages of 18 and 34. The average male Internet gamer plays an average of 21 hours per week, and currently makes up for 85% of the paying Internet game subscribers. An estimated 80% of the computer-owning female population play games. Approximately 50% play games on the Internet or via online services. An estimated 15% of the female group under consideration play Internet games, which are to be classified as typical shooter games. Recently, more and more females are signing on to the Internet for non-shooter games, such as strategy games like Monopoly™ and Clue™.

All this information is used to select an advertisement targeted to a customer with a particular demographic make-up. If for example the analysis of the CPP reveals that the subscriber to the Gaming Service Provider (GSP) for a particular gaming console (GC) is a 27-year-old male, or if the gaming history displays a large number of shooter game requests, advertisement for a new brand of beer would likely meet an audience, which appreciates its message. On the other hand, when the gaming history reveals a large number of requests related to non-shooter and strategy games, an advertisement for a chat room or online dating service is likely to meet an accepting audience.

In addition, when the GSP uses the Internet network to provide gaming services, cooperation with a customer's Internet Service Provider (ISP) allows for a more detailed user classification. Typically, the ISP has access to precise demographic data on each of the ISP customers. The ISP also has access to data on the periods of usage, including the type of customers accessing the Internet during such periods of usage. With this information, which is available only to the ISP, a profile is possibly compiled by the ISP. The profile provides precise information and demographic data on the ISP customers. Cottingham et al. teaches a method how this information is used to provide precise control over who receives an advertisement. When the information about a certain customer collected by the ISP is made available to the GSP, provided that a certain customer subscribes to services of both the GSP and the ISP, then the information is optionally used in selecting a targeted advertisement to be sent to the gaming console (GC) of the certain customer. Furthermore, the history of Uniform Resource Locators (URL) requested by a certain customer is optionally used, to set up a detailed customer personal profile (CPP).

When a customer personal profile is analyzed, the customer is classified according to a set of predefined classes. Optionally, each advertisement out of the plurality of advertisements is classified as belonging to one or several of the predefined classes, and an advertisement is selected as to match best the classification of the customer.

In the context of step 204 it is noted that the considerations for a pricing system made in connection with step 104 of procedure 1 equally apply to procedure 2. In practice, the Gaming Service Provider (GSP) and the Internet Service Provider (ISP) are often the same entity.

After the advertisement has been selected, it is transmitted to the customer gaming console (GC), step 205. Next, it is determined, whether a game is played on the customer GC, step 207. If a game is playing, than the procedure steps back to step 204, and the advertisement is resent to the GC. If a game is not played on the GC, then the advertisement is displayed on the GC, step 208, and the end of the procedure 2 (EOP) is reached, step 299. Inserting step 207 into the procedure ensures that displaying an advertisement most likely does not interfere with the customer playing a game. It is highly disadvantageous to the GSP, when the service provided to the customer suffers a major loss in quality due to the incorporation of advertisement, since this is almost guaranteed to cause customer dissatisfaction.

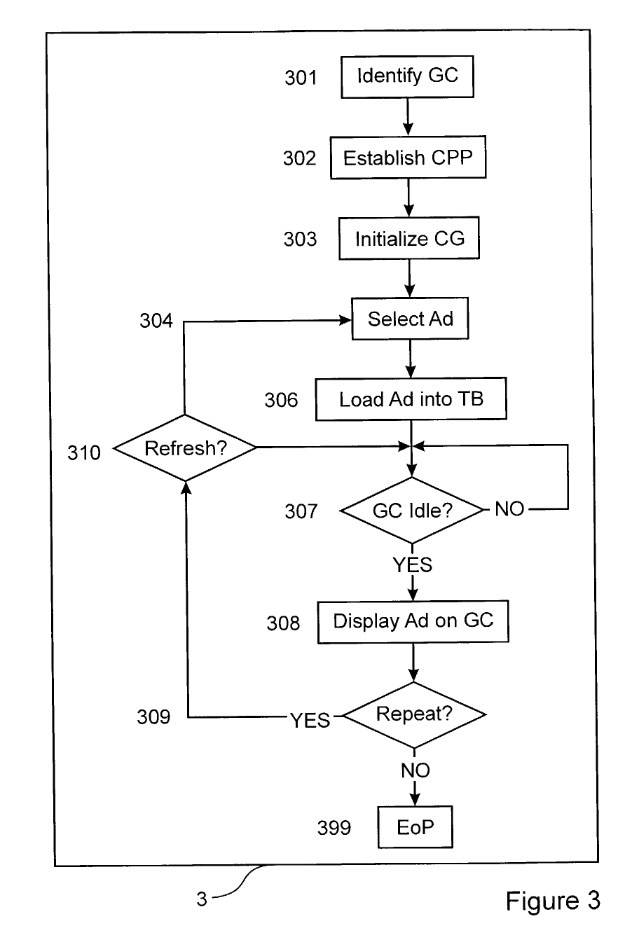

Referring now to FIG. 3, a simplified flow diagram is shown illustrating basic steps of an enhanced procedure 3 according to a third embodiment of the present invention. The procedure 3 begins with the identifying the customer gaming console (GC), step 301, followed by establishing a customer personal profile (CPP), step 302, initializing the GC, step 303, and selecting an advertisement out of a plurality of advertisements, step 304. The steps 301, 302, 303, and 304 are similar to the steps 201, 202, 203, and 204, and similar considerations apply. In the next step 306, the selected advertisement is loaded into a temporary buffer (TB). There exist various possibilities how to set up a TB. For example, memory resources of the customer gaming console (GC) are used as TB. Alternatively, memory resources of a connection device used to establish a connection between the GC and the GSP are used as temporary buffer (TB). This way, advertising on the GC does not deplete hardware resources of the GC, which in turn may possibly affect the gaming experience of the customer. In case memory resources of the GC are used as temporary buffer (TB), the initializing step 303 gains special importance as during this step flushing of memory resources of the GC is performed, which then are used as TB.

After the advertisement has been loaded into the temporary buffer (TB), it is determined whether the customer gaming console (GC) is idle, step 307. The GC is idle, when for example the GC is initialized, but no game is being played on the GC. The GC is also idle, when the game played by the customer is paused or interrupted.

In case the GC is idle, an advertisement is displayed on the GC, step 308. After the advertisement has been displayed it is determined whether the step of displaying an advertisement is to be repeated, step 309. This decision-making process is optionally coupled to the price paid by the customer for the gaming service. A low rate for subscription to the GSP is accompanied by a high frequency of advertisement. On the other hand, the customer possibly opts for a service, in which no advertisements are displayed, for a substantially higher subscription rate.

If the repeat-decision is positively answered, it is decided whether to refresh the temporary buffer (TB), or whether the advertisement previously displayed is lined-up for being repeatedly displayed, step 310. Optionally, a sequence of related advertisements has been loaded into the TB, which are then displayed in series, whenever the repeat-decision is positively answered.

If the refresh-decision is positive, the procedure steps back to step 304, and a new advertisement is selected out of the plurality of advertisements. The repeat step optionally not only reflects the pricing system applied for offering the gaming service to the customer, but also the pricing system for the advertiser. The price of the advertisement is determined considering both downloading the advertisement to the temporary buffer (TB), as well as the number of times the advertisement is actually displayed.

If the repeat decision is negatively answered, the end of the procedure 3 (EOP) is reached, step 399. Optionally, the whole procedure 3 is repeated.

The above-described procedures 1, 2, and 3 have been described as being executed from the customer's gaming console (GC). Alternatively, the Gaming Service Provider (GSP) performs the same procedures. In this case, for example, the advertisements are not downloaded by the customer GC, but are uploaded to the customer GC. Similar modifications apply to other steps of the above procedures 1, 2, and 3. Nevertheless, the basic principles and ideas for displaying an advertisement on a customer gaming console (GC) remain the same.

Furthermore, it is noted that the procedures 1, 2, and 3 represent basic procedures, to be easily modified by those of skill in the art. For example, certain delay loops and waiting steps, affecting the time flow of the procedures, are implemented without difficulties.

The above-described procedures are also applicable for advertising on a customer gaming console (GC), which is not connected to a wide area network such as the Internet network, but which is connected to a local area network (LAN) or is used in a stand-alone fashion. In this case, a gaming cartridge or a compact disc on which games are stored typically takes on the function of the Gaming Service Provider (GSP).

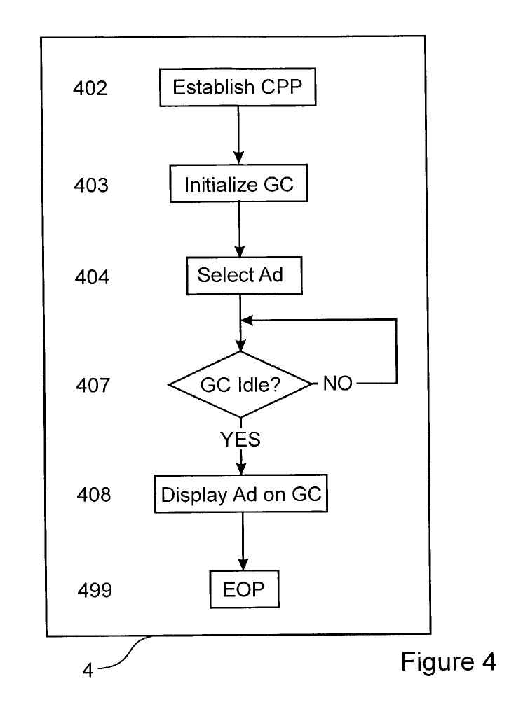

A simplified flow diagram for a basic procedure 4 is shown in FIG. 4. A customer personal profile (CPP) is established, step 402. This step is typically performed using information provided by the customer to the customer gaming console (GC). Next, the GC is initialized, step 403. In this step, a game is typically loaded form a storage device such as a cartridge comprising read-only memory (ROM), or a compact disc. Next, an advertisement out of a plurality of advertisements is selected, step 404. Preferably, the plurality of advertisement is stored on the same storage device as the game loaded to the customer GC. Information provided in the CPP is used to select the advertisement. Optionally, the plurality of advertisements put on the storage device comply to a same customer classification as the game stored on the storage device. It is then determined, whether the customer GC is idle, step 407, and in case the decision results in a negative answer, an advertisement is displayed, step 408. After the end of the procedure 4 (EOP) is reached, step 499, the procedure is optionally repeated. The same considerations and modifications described for procedures 1, 2, and 3 for displaying an advertisement on a customer gaming console (GC) connected to a wide area network, apply to procedure 4 as well.

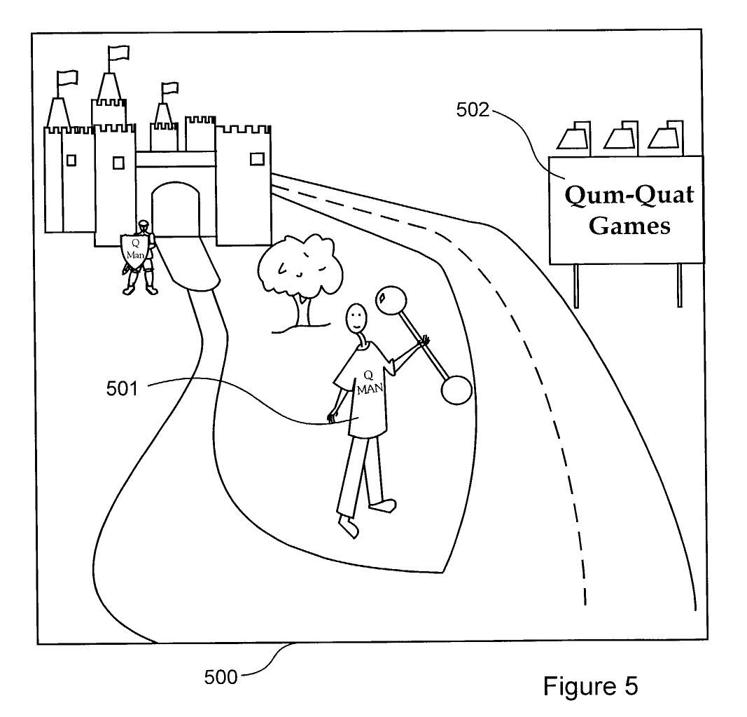

Referring now to FIG. 5, a schematic screenshot 500 is shown of a game played on a customer gaming console. Here, the customer gaming console offers designated advertising spaces and/or generic advertising logos displayed therein. Preferably, the locations of the designated advertising spaces and/or advertising logos are variable, and are selected in connection with a game played on the gaming console. For example, a designated advertising space 501 is associated with a T-shirt worn by the hero in the game, and it is used so that the hero of the game wears a shirt, which has emblazoned thereon the name of the game. In another example, a billboard being part of the city scenario, in which the story of the game takes place, displays the advertising logo of the producer of the game 502. Optionally, other advertisements selected from a plurality of advertisements are displayed on the designated advertising space. The game source provides strict guidelines for provision of new logos for use within the game. Therefore, the steps of selecting an advertisement out of a plurality of advertisements, steps 104, 204, 304, and 404 of the methods illustrated above, are carried out in connection with information provided by the game played on the gaming console. In this case, an advertisement out of the plurality of advertisements will be referred to as a logo. Thus, when a game is initialized, it transmits to the GSP a list of predetermined logo formats. Optionally, other information is included indicating a desirability/cost structure for each logo. Logos having the predetermined format are then provided from the GSP to the GC for display during the game within gaming frames—normal video frames of the video game—and within the action of the game. The logos are positioned in the designated advertising space provided by the game executed on the GC. This provides for an equivalent to “product placements” as provided in the movies within a gaming environment.

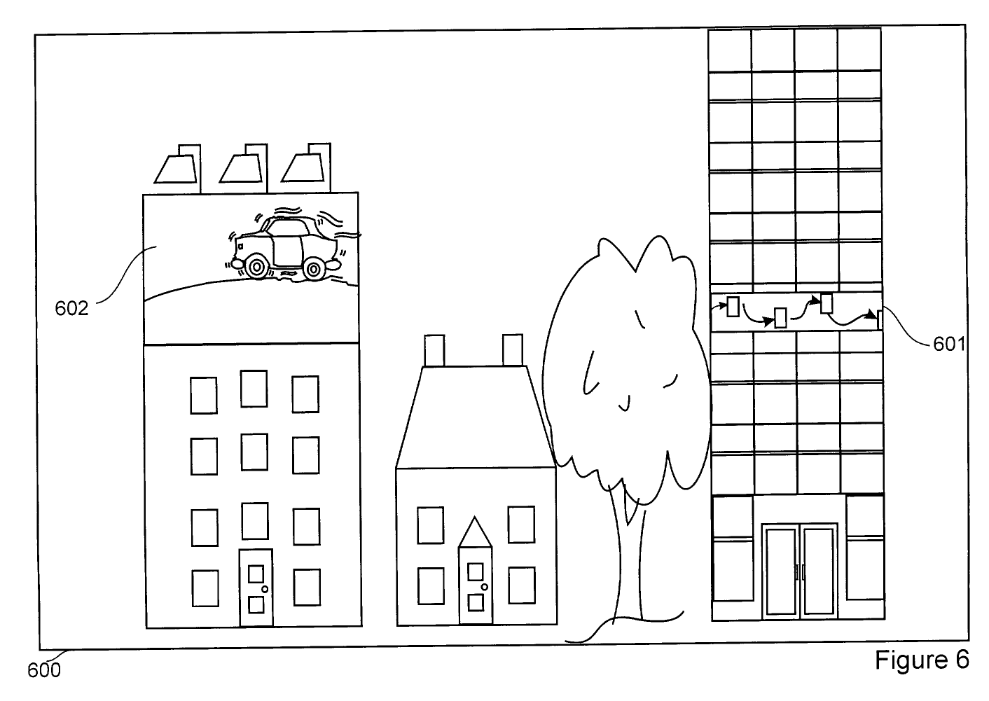

Referring now to FIG. 6, schematic screenshot 600 is shown of a game played on a customer gaming console in which are displayed animated logos or advertisement sequences. In contrast to the static advertisements as described in connection with FIG. 5, the animated sequences are optionally used to display movies or snapshot sequences. For example, a series of advertising logos, which all relate to one common product, or which relate to different products, is displayed in designated spaces 601. A logo shows up for a predetermined period of time, and is then replaced by another logo. Optionally, the same logo reappears at a different designated advertising space. In another example, an animated sequence or a video is displayed in a designated space 602. The criteria for selection of logos and videos are the same as described in connection with FIG. 5. The game source provides strict guidelines regarding formats and other specifications of still pictures as well as animated pictures.

The present invention has been described in connection with a customer gaming consol connected to a wide area network, but a person skilled in the art easily appreciates that the basic ideas of the present invention easily apply to other types of gaming console. For example, the strategies for displaying advertisements as elucidated above are optionally used in connection with a gaming console, which loads a game to be executed form a local storage medium, such as a compact disc on which the game is stored. The plurality of advertisement is then favorably included with the compact disc on which the game to be played is stored.

Although the instant invention has been described with respect to specific embodiments thereof, various changes and modifications are optionally carried out by those skilled in the art without departing from the scope of the invention. Therefore, it is intended that the instant invention encompass such changes and modifications as fall within the scope of the appended claims.

What is claimed is:

1. A method of advertising for use by a Gaming Service Provider providing a customer gaming console in connection with a wide area network, the method comprising the steps of:
providing an identification from the customer gaming console to a Gaming Service Provider;
downloading an advertisement out of a plurality of advertisements to the customer gaming console;
initializing the customer gaming console for playing a game and for displaying the advertisement;
playing a game on the customer gaming console; and
displaying the advertisement on the customer gaming console, when the game is not being played.

2. A method of advertising for use by a Gaming Service Provider according to claim 1, wherein the step of providing an identification includes providing a customer personal profile, the customer personal profile for use in determining restrictions on gaming provided to the customer gaming console, and wherein the step of downloading is performed in dependence upon the provided customer personal profile.

3. A method of advertising for use by a Gaming Service Provider according to claim 1, wherein the step of providing an identification includes providing a customer personal profile, the customer personal profile formed in dependence upon gaming executed on the customers gaming console, and wherein the step of downloading is performed in dependence upon the provided customer personal profile.

4. A method of advertising for use by a Gaming Service Provider according to claim 1, wherein the step of providing an identification includes providing a customer personal profile, the customer personal profile reflecting the customer's personal data provided to the Gaming Service Provider, and wherein the step of downloading is performed in dependence upon the provided customer personal profile.

5. A method of advertising for use by a Gaming Service Provider according to claim 4, wherein the customer personal profile is determined from data collected by the customer's Gaming Service Provider.

6. A method of advertising for use by a Gaming Service Provider according to claim 1, wherein a frequency of displaying the advertisement on the users gaming console is determined according to a fee charged to the customer for connecting to the Gaming Service Provider.

7. A method of advertising for use by a Gaming Service Provider according to claim 1, wherein the step of downloading an advertisement out of a plurality of advertisements to the customer's gaming console includes a step of downloading the advertisement out of a plurality of advertisements to a temporary buffer, and storing said advertisement in said temporary buffer.

8. A method of advertising for use by a Gaming Service Provider according to claim 7, wherein in the step of displaying an advertisement on the customer's gaming console, the advertisement stored in the temporary buffer is displayed on the customers gaming console whenever the customer's gaming console is initialized but idle.

9. A method of advertising for use by a Gaming Service Provider according to claim 7, wherein in the step of displaying an advertisement on the customer's gaming console, the advertisement stored in the temporary buffer is displayed on the customers gaming console whenever the game played on the customer's gaming console is interrupted.

10. A method of advertising for use by a Gaming Service Provider according to claim 7, further comprising the step of:
refreshing the advertisement stored in the temporary buffer by downloading and storing another advertisement out of the plurality of advertisements in the temporary buffer.

11. A method of advertising for use by a Gaming Service Provider according to claim 10, wherein refreshing the temporary buffer is done periodically with a predetermined time interval.

12. A method of advertising for use by a Gaming Service Provider according to claim 7, wherein memory resources of the gaming console serve as the temporary buffer.

13. A method of advertising for use by a Gaming Service Provider according to claim 7, wherein memory resources of a connection device establishing a connection between the customer's gaming console and the Gaming Service Provider serve as the temporary buffer.

14. A method of advertising for use by a Gaming Service Provider according to claim 7, wherein the step of downloading the advertisement out of a plurality of advertisements to a temporary buffer is only performed in connection with the step of displaying the advertisement on the customer's gaming console.

15. A method of advertising for use by a Gaming Service Provider according to claim 1, wherein the step of displaying the advertisement on the customer gaming console is performed independently of whether a game is played on the customer gaming console.

16. A method of advertising for use with a customer gaming console, the customer gaming console being in connection with a wide area network, the method comprising the steps of:
sending an identification from the customer gaming console to a Gaming Service Provider;
uploading an advertisement out of a plurality of advertisements to the customer gaming console for displaying the advertisement on the customer's gaming console.
initializing the customer gaming console for playing a game and for displaying the advertisement;
playing a game on the customer gaming console; and
displaying the advertisement on the customer gaming console, when the game is not being played.

17. A method of advertising for use with the customer gaming console according to claim 16, wherein the step of sending an identification includes sending a customer personal profile, the customer personal profile for use in determining restrictions on gaming provided to the customer gaming console, and wherein the step of uploading is performed in dependence upon the provided customer personal profile.

18. A method of advertising for use with the customer gaming console according to claim 16, wherein the step of sending an identification includes sending a customer personal profile, the customer personal profile formed in dependence upon gaming executed on the customers gaming console, and wherein the step of uploading is performed in dependence upon the provided customer personal profile.

19. A method of advertising for use with the customer gaming console according to claim 16, wherein the step of sending an identification includes sending a customer personal profile, the customer personal profile reflecting the customer's personal data provided to the Gaming Service Provider, and wherein the step of uploading is performed in dependence upon the provided customer personal profile.

20. A method of advertising for use with the customer gaming console according to claim 19, wherein the customer personal profile is determined from data collected by the Gaming Service Provider.

21. A method of advertising for use with the customer gaming console according to claim 16, wherein a frequency of displaying the advertisement on the users gaming console is determined according to a fee charged to the customer for connecting to the Gaming Service Provider.

22. A method of advertising for use with a customer gaming console according to claim 16, wherein the step of uploading an advertisement out of a plurality of advertisements to the customer's gaming console includes a step of uploading the advertisement out of a plurality of advertisements to a temporary buffer, and storing said advertisement in said temporary buffer.

23. A method of advertising for use with the customer gaming console according to claim 22, wherein in the step of displaying an advertisement on the customer's gaming console, the advertisement stored in the temporary buffer is displayed on the customers gaming console whenever the customer's gaming console is initialized but idle.

24. A method of advertising for use with a customer gaming console according to claim 22, wherein in the step of displaying an advertisement on the customer's gaming console, the advertisement stored in the temporary buffer is displayed on the customers gaming console whenever the game played on the customer gaming console is interrupted.

25. A method of advertising for use with a customer gaming console according to claim 22, further comprising the step of refreshing the advertisement stored in the temporary buffer by downloading and storing another advertisement out of the plurality of advertisements in the temporary buffer.

26. A method of advertising for use with a customer gaming console according to claim 25, wherein refreshing the temporary buffer is done periodically with a predetermined time interval.

27. A method of advertising for use with a customer gaming console according to claim 22, wherein memory resources of the gaming console serve as the temporary buffer.

28. A method of advertising for use with a customer gaming console according to claim 22, wherein memory resources of a connection device establishing a connection between the customer gaming console and the Gaming Service Provider serve as the temporary buffer.

29. A method of advertising for use with a customer gaming console according to claim 22, wherein the step of uploading the advertisement out of a plurality of advertisements to a temporary buffer is only performed in connection with the step of displaying the advertisement on the customer gaming console.

30. A method of advertising for use with a customer's gaming console according to claim 16, wherein the step of displaying the advertisement on the customer gaming console is performed independently of whether a game is played on the customer gaming console.

31. A method of advertising on a gaming console, the method comprising the steps of:
loading a game stored on a local storage device onto the gaming console;
loading an advertisement out of a plurality of advertisements stored on the local storage device to gaming console;
initializing the gaming console for playing the game and for displaying the advertisement;
playing the game on the gaming console; and
displaying the advertisement on the gaming console.

32. A method of advertising on a gaming console according to claim 31, wherein the plurality of advertisements stored on the local storage device is selected in relation to the game stored on the local storage device.

33. A method of advertising on a gaming console according to claim 3 1, wherein a frequency of displaying the advertisement on the gaming console is determined according to a price paid by a customer for buying the local storage device comprising the game and the plurality of advertisements.

34. A method of advertising for use by a Gaming Service Provider comprising the steps of:
receiving an identification from a customer gaming console by a Gaming Service Provider;
sending an advertisement out of a plurality of advertisements to the customer gaming console for displaying the advertisement on the customer's gaming console;
downloading a game to be executed to the customer gaming console; and
displaying the advertisement on the customer gaming console while the game is being executed on the customer gaming console.

35. A method of advertising for use by a Gaming Service Provider according to claim 34, wherein the advertisement is a static advertisement.

36. A method of advertising for use by a Gaming Service Provider according to claim 34, wherein the advertisement is an animated advertisement.

37. A method of advertising for use by a Gaming Service Provider according to claim 34, wherein the advertisement is displayed in a designated advertising space, the designated advertising space being selected in connection with the game being executed on the customer gaming console.

38. A method of advertising for use by a Gaming Service Provider according to claim 37, wherein the designated advertising space is incorporated into the game being executed on the customer gaming console.

39. A method of advertising for use by a Gaming Service Provider according to claim 34, wherein the identification received from the customer gaming console includes information about the game to be executed on the customer gaming console.

40. A method of advertising for use by a Gaming Service Provider according to claim 39, wherein the advertisement out of the plurality of advertisements is selected according to specifications provided by the game being executed on the customer gaming console.

41. A storage medium having stored therein data, the data for performing the steps of:
providing an identification from a customer gaming console to a Gaming Service Provider;
downloading an advertisement out of a plurality of advertisements to the customer gaming console;
initializing the customer gaming console for playing a game and for displaying the advertisement;
playing a game on the customer gaming console; and
displaying the advertisement on the customer gaming console, when the game is not being played.

42. A storage medium having stored therein data according to claim 41, wherein the data for performing the step of providing an identification include data for performing the step of providing a customer personal profile, the customer personal profile for use in determining restrictions on gaming provided to the customer gaming console, and wherein the data for performing the step of downloading includes data for performing the step of downloading in dependence upon the provided customer personal profile.

43. A storage medium having stored therein data according to claim 41, wherein the data for performing the step of providing an identification include data for providing a customer personal profile, the customer personal profile formed in dependence upon gaming executed on the customers gaming console, and wherein the data for the step of downloading includes data for performing the step of downloading in dependence upon the provided customer personal profile.

44. A storage medium having stored therein data according to claim 41, wherein the data for performing the step of providing an identification include data for providing a customer personal profile, the customer personal profile reflecting the customer personal data provided to the Gaming Service Provider, and wherein the data for performing the step of downloading includes data for performing the step of downloading in dependence upon the provided customer personal profile.

45. A storage medium having stored therein data according to claim 44, wherein the customer personal profile is determined from data collected by the customer's Gaming Service Provider.

46. A storage medium having stored therein data according to claim 41, wherein the data include data for determining a frequency of displaying the advertisement on the customer gaming console according to a fee charged to the customer for connecting to the Gaming Service Provider.

47. A storage medium having stored therein data according to claim 41, wherein the data for performing the step of downloading an advertisement out of a plurality of advertisements to the customer gaming console includes data for performing a step of downloading the advertisement out of a plurality of advertisements to a temporary buffer, and storing said advertisement in said temporary buffer.

48. A storage medium having stored therein data according to claim 47, wherein the data for performing the step of displaying an advertisement on the customer's gaming console include data for performing the step of displaying the advertisement stored in the temporary buffer on the customers gaming console whenever the customer's gaming console is initialized but idle.

49. A storage medium having stored therein data according to claim 47, wherein the data for performing the step of displaying an advertisement on the customer's gaming console include data for performing the step of displaying the advertisement stored in the temporary buffer on the customers gaming console whenever the game played on the customer's gaming console is interrupted.

50 A storage medium having stored therein data according to claim 47, the data further comprising data for performing the step of refreshing the advertisement stored in the temporary buffer by downloading and storing another advertisement out of the plurality of advertisements in the temporary buffer.

51. A storage medium having stored therein data according to claim 50, wherein the data for performing the step of refreshing the temporary buffer include data for performing the step of refreshing the temporary buffer periodically with a predetermined time interval.

52. A storage medium having stored therein data according to claim 47, wherein memory resources of the gaming console serve as the temporary buffer.

53. A storage medium having stored therein data according to claim 47, wherein memory resources of a connection device establishing a connection between the customer's gaming console and the Gaming Service Provider serve as the temporary buffer.

54. A storage medium having stored therein data according to claim 47, wherein the data for performing the step of downloading the advertisement out of a plurality of advertisements to a temporary buffer include data for performing the step of downloading the advertisement out of a plurality of advertisements to a temporary buffer only in connection with the step of displaying the advertisement on the customer's gaming console.

55. A storage medium having stored therein data according to claim 41, wherein the data for performing the step of displaying the advertisement on the customer gaming console include data for performing the step of displaying the advertisement on the customer gaming console independently of whether a game is played on the customer gaming console.

56. A storage medium having stored therein data, the data for performing the steps of:
sending an identification from a customer gaming console to a Gaming Service Provider;
uploading an advertisement out of a plurality of advertisements to the customer gaming console;
initializing the customer gaming console for playing a game and for displaying the advertisement;
playing a game on the customer gaming console; and
displaying the advertisement on the customer gaming console, when the game is not being played.

57. A storage medium having stored therein data according to claim 56, wherein the data for performing the step of sending an identification include data for performing the step of sending a customer personal profile, the customer personal profile for use in determining restrictions on gaming send to the customer gaming console, and wherein the data for performing the step of downloading includes data for performing the step of downloading in dependence upon the sent customer personal profile.

58. A storage medium having stored therein data according to claim 56, wherein the data for performing the step of sending an identification include data for sending a customer personal profile, the customer personal profile formed in dependence upon gaming executed on the customers gaming console, and wherein the data for the step of downloading includes data for performing the step of uploading in dependence upon the sent customer personal profile.

59. A storage medium having stored therein data according to claim 56, wherein the data for performing the step of sending an identification include data for sending a customer personal profile, the customer personal profile reflecting the customer personal data sent to the Gaming Service Provider, and wherein the data for performing the step of uploading includes data for performing the step of uploading in dependence upon the sent customer personal profile.

60. A storage medium having stored therein data according to claim 59, wherein the customer personal profile is determined from data collected by the customer's Gaming Service Provider.

61. A storage medium having stored therein data according to claim 56, wherein the data include data for determining a frequency of displaying the advertisement on the customer gaming console according to a fee charged to the customer for connecting to the Gaming Service Provider.

62. A storage medium having stored therein data according to claim 56, wherein the data for performing the step of uploading an advertisement out of a plurality of advertisements to the customer gaming console includes data for performing a step of uploading the advertisement out of a plurality of advertisements to a temporary buffer, and storing said advertisement in said temporary buffer.

63. A storage medium having stored therein data according to claim 62, wherein the data for performing the step of displaying an advertisement on the customer's gaming console include data for performing the step of displaying the advertisement stored in the temporary buffer on the customers gaming console whenever the customer's gaming console is initialized but idle.

64. A storage medium having stored therein data according to claim 62, wherein the data for performing the step of displaying an advertisement on the customer's gaming console include data for performing the step of displaying the advertisement stored in the temporary buffer on the customers gaming console whenever the game played on the customer's gaming console is interrupted.

65. A storage medium having stored therein data according to claim 62, the data further comprising data for performing the step of refreshing the advertisement stored in the temporary buffer by uploading and storing another advertisement out of the plurality of advertisements in the temporary buffer.

66. A storage medium having stored therein data according to claim 65, wherein the data for performing the step of refreshing the temporary buffer include data for performing the step of refreshing the temporary buffer periodically with a predetermined time interval.

67. A storage medium having stored therein data according to claim 62, wherein memory resources of the gaming console serve as the temporary buffer.

68. A storage medium having stored therein data according to claim 62, wherein memory resources of a connection device establishing a connection between the customer's gaming console and the Gaming Service Provider serve as the temporary buffer.

69. A storage medium having stored therein data according to claim 62, wherein the data for performing the step of uploading the advertisement out of a plurality of advertisements to a temporary buffer include data for performing the step of uploading the advertisement out of a plurality of advertisements to a temporary buffer only in connection with the step of displaying the advertisement on the customer's gaming console.

70. A storage medium having stored therein data according to claim 56, wherein the data for performing the step of displaying the advertisement on the customer gaming console include data for performing the step of displaying the advertisement on the customer gaming console independently of whether a game is played on the customer gaming console.

71. A storage medium having stored therein data, the data for performing the steps of:
loading a game stored on a local storage device onto the gaming console;
loading an advertisement out of a plurality of advertisements stored on the local storage device to gaming console;
initializing the gaming console for playing the game and for displaying the advertisement;
playing the game on the gaming console; and
displaying the advertisement on the gaming console.

72. A storage medium having stored therein data according to claim 71, wherein the data include a frequency of displaying the advertisement on the gaming console, the frequency being determined according to a price paid by a customer for buying the local storage device comprising the game and the plurality of advertisements.

73. A storage medium having stored therein data, the data for performing the steps of:
receiving an identification from a customer gaming console by a Gaming Service Provider;
sending an advertisement out of a plurality of advertisements to the customer gaming console for displaying the advertisement on the customer's gaming console;
downloading a game to be executed to the customer gaming console; and
displaying the advertisement on the customer gaming console while the game is being executed on the customer gaming console.

74. A storage medium having stored therein data according to claim 73, wherein the advertisement is a static advertisement.

75. A storage medium having stored therein data according to claim 73, wherein the advertisement is an animated advertisement.

76. A storage medium having stored therein data according to claim 73, wherein the data include data for displaying the advertisement in a designated advertising space, the designated advertising space being selected in connection with the game being executed on the customer gaming console.

77. A storage medium having stored therein data according to claim 76, wherein the designated advertising space is incorporated into the game being executed on the customer gaming console.

78. A storage medium having stored therein data according to claim 73, wherein the identification received from the customer gaming console includes information about the game to be executed on the customer gaming console.

79. A storage medium having stored therein data according to claim 78, wherein the data include data for performing the step of selecting the advertisement out of the plurality of advertisements according to specifications provided by the game being executed on the customer gaming console.
